(19) United States
(12) Patent Application Publication
(10) Pub. No.: US 2021/0089234 A1
(43) Pub. Date: Mar. 25, 2021

(54) MEMORY SYSTEM

(71) Applicants: Kioxia Corporation, Minato-ku (JP); TOSHIBA INFORMATION SYSTEMS (JAPAN) CORPORATION, Kawasaki-shi (JP)

(72) Inventors: Keisuke YASUI, Fujisawa (JP); Ryuji NISHIKUBO, Kawasaki (JP); Norio AOYAMA, Machida (JP)

(73) Assignees: Kioxia Corporation, Minato-ku (JP); TOSHIBA INFORMATION SYSTEMS (JAPAN) CORPORATION, Kawasaki-shi (JP)

(21) Appl. No.: 16/818,775

(22) Filed: Mar. 13, 2020

(30) Foreign Application Priority Data
Sep. 20, 2019 (JP) 2019-171296

(51) Int. Cl. G06F 3/06; G06Q 40/02; G06Q 10/06

(52) U.S. Cl. CPC G06F 3/0659; G06F 3/0604; G06Q 10/0631; G06Q 40/02; G06F 3/0679

(57) ABSTRACT

According to one embodiment, a memory system includes a nonvolatile memory device to store data; and a memory controller configured to: manage first information allocated to each user and including first management data; perform first processing for an access to the nonvolatile memory device when an access request to the nonvolatile memory device has been received from the user and the first management data is equal to or larger than a first value; and perform second processing for an access to the nonvolatile memory device when the first management data is equal to or larger than a second value.

### CROSS-REFERENCE TO RELATED APPLICATIONS

This application is based upon and claims the benefit of priority from prior Japanese Patent Application No. 2019-171296, filed Sep. 20, 2019, the entire contents of which are incorporated herein by reference.

### FIELD

Embodiments described herein relate generally to a memory system.

### BACKGROUND

As a nonvolatile semiconductor memory device, a NAND flash memory chip is known.

### BRIEF DESCRIPTION OF THE DRAWINGS

FIG. 1 is a block diagram showing a configuration example of a memory system 1 according to an embodiment.

FIG. 2 is a block diagram showing a configuration example of a NAND flash memory chip of the memory system according to the embodiment.

FIG. 3 is a circuit diagram showing a configuration example of a memory cell array of the NAND flash memory chip of the memory system according to the embodiment.

FIG. 4 is a diagram showing storable data, threshold voltage distribution, and voltages used for reading of memory cell transistors MT.

FIG. 5 is a block diagram showing a configuration example of an access manager of a memory system according to the embodiment.

FIG. 6 shows data structures of a plurality of queues according to the embodiment.

FIG. 7 is a flowchart showing a first operation of the memory system according to the embodiment.

FIG. 8 is a block diagram showing the first operation of the memory system according to the embodiment.

FIG. 9 is a flowchart showing a second operation of the memory system according to the embodiment.

FIG. 10 is a block diagram showing the second operation of the memory system according to the embodiment.

FIG. 11 is a flowchart showing a third operation of the memory system according to the embodiment.

FIG. 12 is a block diagram showing the third operation of the memory system according to the embodiment.

FIG. 13 is a flowchart showing a fourth operation of the memory system according to the embodiment.

FIG. 14 is a block diagram showing the fourth operation of the memory system according to the embodiment.

FIG. 15 is a flowchart showing a fifth operation of the memory system according to the embodiment.

FIG. 16 is a block diagram showing the fifth operation of the memory system according to the embodiment.

FIG. 17 is a flowchart showing the fifth operation of the memory system according to the embodiment.

FIG. 18 is a block diagram showing the fifth operation of the memory system according to the embodiment.

FIG. 19 is a flowchart showing a sixth operation of the memory system according to the embodiment.

FIG. 20 is a block diagram showing the sixth operation of the memory system according to the embodiment.

FIG. 21 is a flowchart showing a seventh operation of the memory system according to the embodiment.

FIG. 22 is a block diagram showing the seventh operation of the memory system according to the embodiment.

FIG. 23 is a flowchart showing the seventh operation of the memory system according to the embodiment.

FIG. 24 is a flowchart showing the seventh operation of the memory system according to the embodiment.

FIG. 25 is a flowchart showing the seventh operation of the memory system according to the embodiment.

### DETAILED DESCRIPTION

In generally, according to one embodiment, a memory system includes a nonvolatile memory device to store data; and a memory controller configured to: manage first information allocated to each user and including first management data; perform first processing for an access to the nonvolatile memory device when an access request to the nonvolatile memory device has been received from the user and the first management data is equal to or larger than a first value; and perform second processing for an access to the nonvolatile memory device when the first management data is equal to or larger than a second value.

Hereinafter, an embodiment will be described with reference to the drawings. The drawings are schematic. In the following description, structural elements having substantially the same function and configuration will be assigned the same reference symbol, and redundant explanations are avoided. A numeral following a letter constituting a reference numeral/symbol and a letter following a numeral constituting a reference numeral/symbol are used for distinction between elements referred to by reference numerals/symbols including the same letter or numeral and having the same configuration. When components having reference symbols that contain the same character string or numerals need not be distinguished from each other, these components may be referred to by a reference symbol containing the character string or numerals only.

Each of the function blocks can be implemented in the form of hardware, computer software, or a combination thereof. In order to clarify that each block may be any of these, the block will be described below in terms of their functions in general. Whether the functions are implemented as hardware or software depends on specific embodiments or design restrictions imposed on the entire system. Those skilled in the art can implement the functions in various ways for respective specific embodiments, and determining such an implementation is within the scope of the present invention.

The various types of processing in the embodiment can be implemented by a computer program. Therefore, the processing may be executed through a computer-readable storage medium that stores the computer program by installing the computer program on a common computer.

### <1> Embodiment

Hereinafter, a memory system according to an embodiment will be described. Described in the present embodiment is a memory system installed in a data center, etc. and shared by a plurality of users. Described below are a configuration and method for, in a service for enabling a plurality of users to share the memory system, appropriately allocating, to each user, an access performance corresponding to a billing amount for the service.

For example, the memory system may be installed in a data center, etc. and shared by a plurality of users. In the system in the data center, the occupancy time of a NAND package group varies depending on the method for accessing the NAND package group or the configuration of the NAND package group. It is difficult to manage the occupancy time of a NAND package group from the host device side. There are two prominent types of methods for accessing a NAND package group, namely, “sequential read/sequential write” (also referred to as “sequential access”) and “random read/random write” (also referred to as “random access”). Sequential access is a method for sequentially reading or writing regularly arranged data. In contrast, random access is a method for reading or writing data at random in non-conformity with the order of addresses. When random access is performed, data is stored in a storage area on a chip, and is disorganized. In such a case, the memory system needs to perform an operation (internal access processing) to organize the storage area on the chip. Therefore, for example, when a user performs a random access, the memory system needs to perform internal access processing in addition to the random access. As a result, the chip occupancy time increases, and the access performance of other users decreases; accordingly, the service quality of the memory system deteriorates. In the service for enabling a plurality of users to share a memory system, there is a demand for appropriately allocating, to each user, an access performance corresponding to a billing amount for the service.

### <1-1> Configuration

<1-1-1> Configuration of Memory System 1

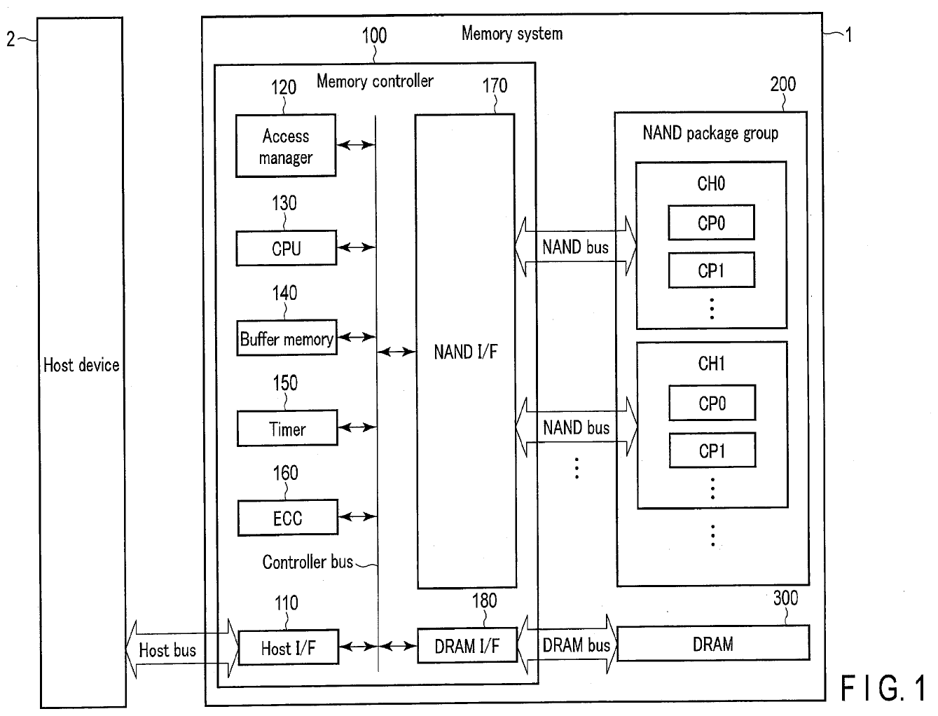

A configuration of a memory system according to an embodiment will be described with reference to FIG. 1. FIG. 1 is a block diagram showing a configuration example of a memory system 1 according to an embodiment.

As shown in FIG. 1, the memory system 1 includes a memory controller 100, a NAND package group 200, and a dynamic random access memory (DRAM) 300. The memory controller 100, NAND package group 200, and DRAM 300 may form one semiconductor device in combination, for example. The semiconductor device is, for example, a memory card such as an SD™ card or a solid state drive (SSD).

The memory controller 100 controls the NAND package group 200 and the DRAM 300. Specifically, the memory controller 100 is an integrated circuit (IC), such as a system on a chip (SoC), a field programmable gate array (FPGA), or an application specific integrated circuit (ASIC), and can order the NAND package group 200 and the DRAM 300 to execute various operations. The memory controller 100 also executes an operation (external access processing) based on a host command (order), and an operation (internal access processing) that does not depend on a host command. A detailed configuration of the memory controller 100 will be described later.

The memory controller 100 is coupled to a host device 2 via a host bus. The memory controller 100 is also coupled to the NAND package group 200 by NAND buses for transmission/reception of signals compliant with the NAND interface to be described later. The memory controller 100 is also coupled to the DRAM 300 by a DRAM bus for transmission/reception of signals compliant with the DRAM interface to be described later. The host device 2 is an information processing apparatus outside the memory system 1. The host device 2 is, for example, a personal computer. The host bus is a bus compliant with, for example, an SD™ interface, a serial attached small computer system interface (SCSI) (SAS), a serial advanced technology attachment (ATA) (SATA), a peripheral component interconnect express (PCIe), or a non-volatile memory express (NVMe).

As the format of data that the memory controller 100 receives from the host device 2, the “stream” method or “namespace” method is adopted. Hereinafter, a method for managing users by adopting the “stream” method will be described as an example. However, the method for managing users is not limited to this, and may be another method. The users mean users who use the memory system 1. The stream can be reworded as a request from a user (or an access request). When the “stream” method is adopted, data is transmitted from the host device 2 to the memory system 1 with the data structure of the specification called a “stream”. For example, a number is assigned to the stream. The number assigned to the stream can be regarded as corresponding to a number for managing users. Namely, by assigning a number to a stream, the memory system 1 can ascertain from which user an access is performed.

The NAND package group 200 is a plurality of nonvolatile memories, which nonvolatilely store data. The NAND package group 200 includes a plurality of channels CH (CH0, CH1, . . . ). Each of the channels CH is individually coupled to the memory controller 100 by a corresponding NAND bus. The number of channels in the NAND package group 200 may be any number. Each of the channels CH includes a plurality of chips CP (CP0, CP1, . . . ). Each of the chips CP is, for example, a NAND flash memory. The number of chips CP in each channel CH may be any number. The other channels CH (not shown) have the same configuration. The configuration of the chip CP will be described later. The following description will be provided while taking a NAND flash memory chip as an example of the chip CP; however, the chip CP is not limited to the NAND flash memory chip, and may be another memory such as a magnetoresistive random access memory (MRAM), a phase change random access memory (PCRAM), or a resistive random access memory (ReRAM).

The DRAM 300 is a volatile memory, which can temporarily store data. The volatile memory included in the memory system 1 is not limited to the DRAM. For example, the memory system 1 may include, for example, a static random access memory (SRAM) as the volatile memory.

The DRAM 300 is used as a working area of a processor 130. The DRAM 300 retains firmware for managing the NAND package group 200, and various management tables, etc., such as a history table to be described later.

<1-1-2> Configuration of Memory Controller

A detailed configuration of the memory controller 100 will be described with continuous reference to FIG. 1.

The memory controller 100 includes a host interface circuit (host I/F) 110, an access manager 120, a processor (central processing unit (CPU)) 130, a buffer memory 140, a timer 150, an error correction code (ECC) circuit 160, NAND interface circuit (NAND I/F) 170, and a DRAM interface circuit (DRAM I/F) 180. The function of each unit of the memory controller 100 to be described below can be implemented by either a hardware configuration or a combined configuration of a hardware resource and firmware.

The host interface circuit 110 is coupled to the host device 2 via a host bus. The host interface circuit 110 receives a stream from the host device 2. This stream includes, for example, a host command and data. A number dedicated to, for example, a user is assigned to the stream. In response to an order of the processor 130, the host interface circuit 110 transfers data in the buffer memory 140 to the host device 2.

The access manager 120 manages the access performance allocated to each user. The access means an operation to write data in a chip CP, an operation to read data from a chip CP, or the like. The access performance relates to a time required for an access to the chip CP. In other words, the occupancy time of the chip CP is long when the access performance is high, whereas the occupancy time of the chip CP is short when the access performance is low.

The processor 130 controls the overall operation of the memory controller 100. For example, the processor 130 executes software stored in the DRAM 300.

The buffer memory 140 temporarily retains write data and read data as well as read data error-corrected by the ECC circuit 160 (also referred to as expected data).

The timer 150 can measure times relating to various operations of the memory system 1. The timer 150 can acquire time information of, for example, a plurality of chips CP operating in parallel. The time information of each chip CP may be stored in, for example, the DRAM 300.

The ECC circuit 160 performs error detection and error correction processing on data stored in the NAND package group 200. Namely, when data is written, the ECC circuit 160 generates an error correction code and provides it to write data. When data is read, the ECC circuit 160 decodes the error correction code, and checks for an error bit. When an error bit is detected, the ECC circuit 160 specifies the location of the error bit and corrects the error. The method for the error correction includes, for example, hard bit decoding and soft bit decoding. As a hard bit decoding code used for the hard bit decoding, a Bose-Chaudhuri-Hocquenghem (BCH) code, a Reed-Solomon (RS) code, or the like can be used. As a soft bit decoding code used for the soft bit decoding, a low density parity check (LDPC) or the like can be used.

The NAND interface circuit 170 is coupled to the NAND package group 200 via the NAND buses, and controls communication between the memory controller 100 and the NAND package group 200. The NAND interface circuit 170 transmits or receives various signals to be described later to or from the NAND package group 200 based on orders received from the access manager 120.

The DRAM interface circuit 180 is coupled to the DRAM 300 via the DRAM bus, and controls communication with the DRAM 300. The DRAM interface circuit 180 transmits or receives various signals to be described later to or from the DRAM 300 based on orders received from the access manager 120.

<1-1-3> Configuration of Chip

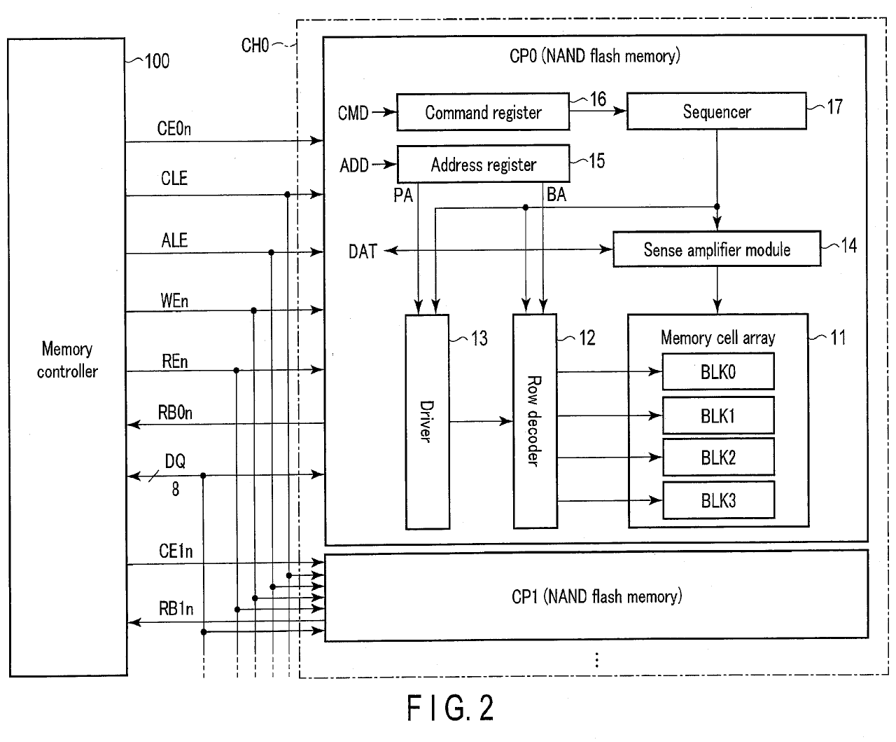

Next, the configuration of the chip CP will be described with reference to FIG. 2. FIG. 2 shows the coupling relationship between the memory controller 100 and channel CH0 and the configuration of one chip CP0 in channel CH0 as an example.

First, the coupling relationship between the memory controller 100 and channel CH0 will be described. The coupling relationship between the memory controller 100 and each of the other channels, such as CH1, is the same as the coupling relationship between the memory controller 100 and channel CH0, and a description thereof will be omitted.

As shown in FIG. 2, channel CH0 is coupled to the memory controller 100, and transmits and receives various signals. The various signals include, for example, a chip enable signal CEn (CE0n, CE1n, . . . ), an address latch enable signal ALE, a command latch enable signal CLE, a write enable signal WEn, a read enable signal REn, a ready/busy signal RBn (RB0n, RB1n, . . . ), and an input/output signal DQ. Signals CE0n, CE1n, . . . are separately input to the respective chips CP (chips CP0, CP1, . . . ) of channel CH0, and signals RBn0, RBn1, . . . are separately output from the respective chips CP of channel CH0. Signals ALE, CLE, WEn, REn, and DQ are input in common to each chip CP of channel CH0.

Specifically, signals CE0n, CE1n, . . . are signals for enabling respective chips CP0, CP1, . . . , and are asserted at a “low (L)” level. Signals CLE and ALE are signals for notifying each chip CP that the input/output signal DQ to the chip CP is a command and an address, respectively. Signal WEn is asserted at the “L” level, and is a signal for causing each chip CP to take an input signal DQ therein. Signal REn is also asserted at the “L” level, and is a signal for reading an output signal DQ from each chip CP. The ready/busy signals RB0n, RB1n, are signals for indicating whether the respective chips CP0, CP1, . . . are in a ready state (a state where a command from the memory controller 100 can be received) or in a busy state (a state where a command from the memory controller 100 cannot be received), and the “L” level indicates the busy state. The input/output signal DQ is, for example, an 8-bit signal. The input/output signal DQ is an entity of data transmitted and received between each chip CP and the memory controller 100, and is data DAT, such as a command CMD, an address ADD, write data, read data, or the like.

Since CH0 is configured as described above, the memory controller 100 can communicate with a given chip CP in the channel CH.

Next, the configuration of chip CP0 in channel CH0 will be described. The configurations of the other chips, such as CP1, are the same as that of chip CP0, and descriptions thereof will be omitted.

Chip CP0 includes a memory cell array 11, a row decoder 12, a driver 13, a sense amplifier module 14, an address register 15, a command register 16, and a sequencer 17.

The memory cell array 11 stores data provided by the controller 100. The memory cell array 11 includes a plurality of blocks BLK each including a plurality of nonvolatile memory cells each associated with a row and a column. FIG. 2 shows four blocks BLK0 to BLK3 as an example.

The row decoder 12 selects one of the blocks BLK based on a block address BA in the address register 15, and further selects a word line in the selected block BLK.

The driver 13 supplies a voltage to the selected block BLK via the row decoder 12 based on a page address PA in the address register 15.

When reading data, the sense amplifier module 14 senses threshold voltages of memory cell transistors in the memory cell array 11, thereby reading data. The sense amplifier module 14 then outputs the read data DAT to the memory controller 100. When writing data, the sense amplifier module 14 transfers write data DAT received from the memory controller 100 to the memory cell array 11.

The address register 15 retains an address ADD received from the memory controller 100. The address ADD includes the above-mentioned block address BA and page address PA.

The command register 16 retains a command CMD received from the memory controller 100.

The sequencer 17 controls the overall operation of chip CP0 based on the command CMD retained in the command register 16.

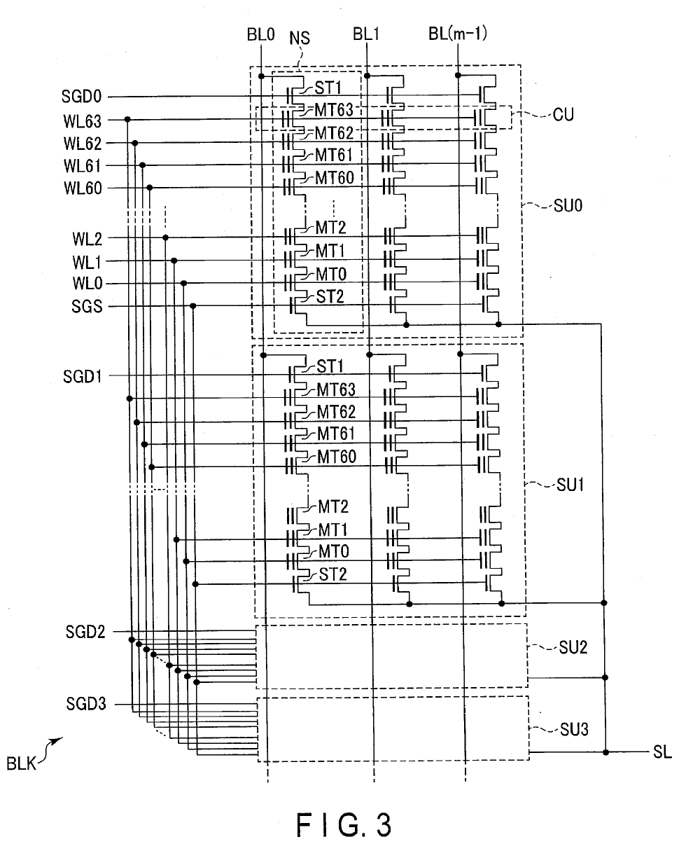

Next, the configuration of a block BLK included in the memory cell array 11 will be described with reference to FIG. 3. FIG. 3 is a circuit diagram of a block BLK.

As shown in FIG. 3, the block BLK includes, for example, four string units SU (SU0 to SU3). Each of the string units SU includes a plurality of NAND strings NS. The number of blocks in the memory cell array 11, the number of string units in each block BLK, and the number of NAND strings in each string unit SU may be any number.

Each of the NAND strings NS includes, for example, 64 memory cell transistors MT (MT0 to MT63) and select transistors ST1 and ST2. Each of the memory cell transistors MT includes a control gate and a charge storage layer, and nonvolatilely retains data. The memory cell transistors MT are coupled in series between the source of select transistor ST1 and the drain of select transistor ST2.

The gates of select transistors ST1 in string units SU0 to SU3 are coupled to respective select gate lines SGD0 to SGD3. On the other hand, the gates of select transistors ST2 in string units SU0 to SU3 are coupled in common to, for example, select gate line SGS. Alternatively, the gates of select transistors ST2 in string units SU0 to SU3 may be coupled to different select gate lines SGS0 to SGS3, respectively. In addition, the control gates of the memory cell transistors MT0 to MT63 in the same block BLK are coupled in common to the word lines WL0 to WL63, respectively.

The drains of select transistors ST1 of the NAND strings NS in the same column in the memory cell array 11 are coupled in common to a bit line BL (BL0 to BL(m−1), where m is a natural number equal to or larger than 2). Namely, the NAND strings NS in the same column of a plurality of blocks BLK are coupled in common to a bit line BL. Moreover, the sources of a plurality of select transistors ST2 are coupled in common to a source line SL.

In other words, each string unit SU is a set of NAND strings NS coupled to different bit lines BL and coupled to the same select gate line SGD. A set of a plurality of memory cell transistors MT coupled in common to the same word line WL in each string unit SU is referred to as a cell unit CU (or a memory group). Each block BLK is a set of a plurality of string units SU that share the word lines WL. The memory cell array 11 is a set of blocks BLK that share the bit lines BL.

In this example, one memory cell transistor MT can retain, for example, 2-bit data. The bits of the 2-bit data will be referred to as a lower bit and an upper bit in ascending order from the least significant bit. The set of lower bits retained by the memory cells in the same cell unit CU is called a lower page, and the set of upper bits is called an upper page. Namely, two pages are assigned to one word line WL (one cell unit CU) in one string unit SU, and one string unit SU has a capacity of 128 pages. In other words, “page” may also be defined as a part of a memory space formed by a cell unit CU. Data may be written and read for each page or each cell unit CU.

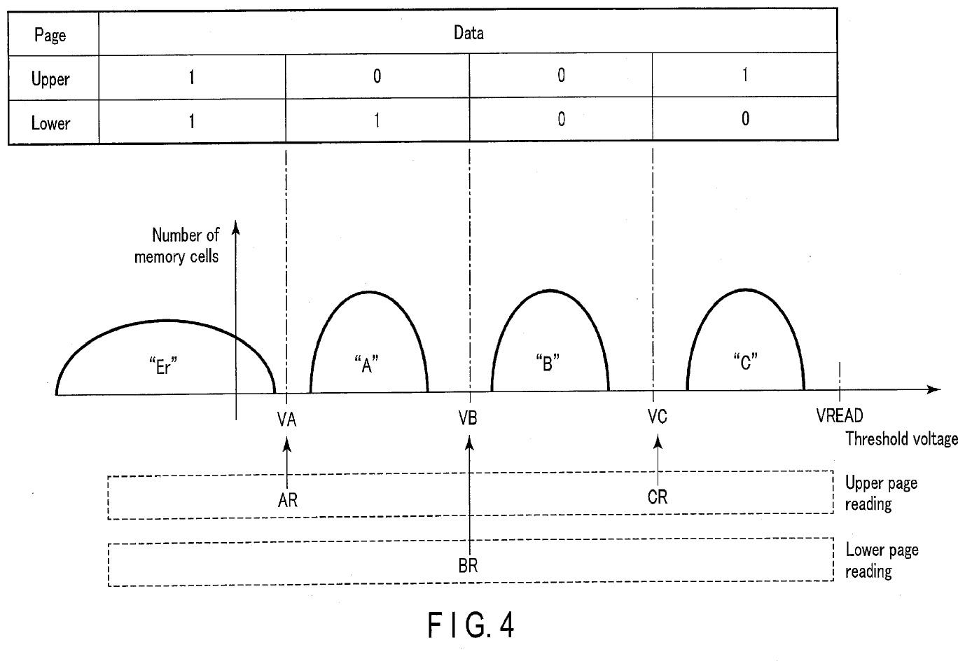

FIG. 4 is a diagram showing storable data, threshold voltage distribution, and voltages used for reading of memory cell transistors MT.

As described above, each memory cell transistor MT can retain 2-bit data. Namely, the memory cell transistors MT can take four states in accordance with their threshold voltages. The four states will be referred to as an “Er” state, “A” state, “B” state, and “C” state in ascending order of threshold voltage.

When a memory cell transistor MT is in the “Er” state, the threshold voltage of the memory cell transistor MT is lower than voltage VA, and the memory cell transistor MT is in a data-erased state. When a memory cell transistor MT is in the “A” state, the threshold voltage of the memory cell transistor MT is equal to or higher than voltage VA and lower than voltage VB (>VA). When a memory cell transistor MT is in the “B” state, the threshold voltage of the memory cell transistor MT is equal to or higher than voltage VB and lower than voltage VC (>VB). When a memory cell transistor MT is in the “C” state, the threshold voltage of the memory cell transistor MT is equal to or higher than voltage VC and lower than voltage VREAD. Of the four states distributed in this way, the “C” state is the highest threshold voltage state. Voltages VA to VC are also collectively referred to as voltage VCGR. Voltage VREAD is a voltage applied to word lines WL that are not read targets in a read operation, which turns on memory cell transistors MT regardless of data retained therein.

The above-described threshold voltage distribution is obtained by writing 2-bit (2-page) data constituted by the above-mentioned lower bit and upper bit. The relationship between the “Er” to “C” states and the lower bit and upper bit is as follows:

“Er” state: “11” (in the order of “upper/lower”)
“A” state: “01”
“B” state: “00”
“C” state: “10”
Only one of the two bits is different between data corresponding to two adjacent states in the threshold voltage distribution.

Accordingly, when the lower bit is read, a voltage corresponding to the boundary where the value (“0” or “1”) of the lower bit changes may be used; this also applies when reading the upper bit.

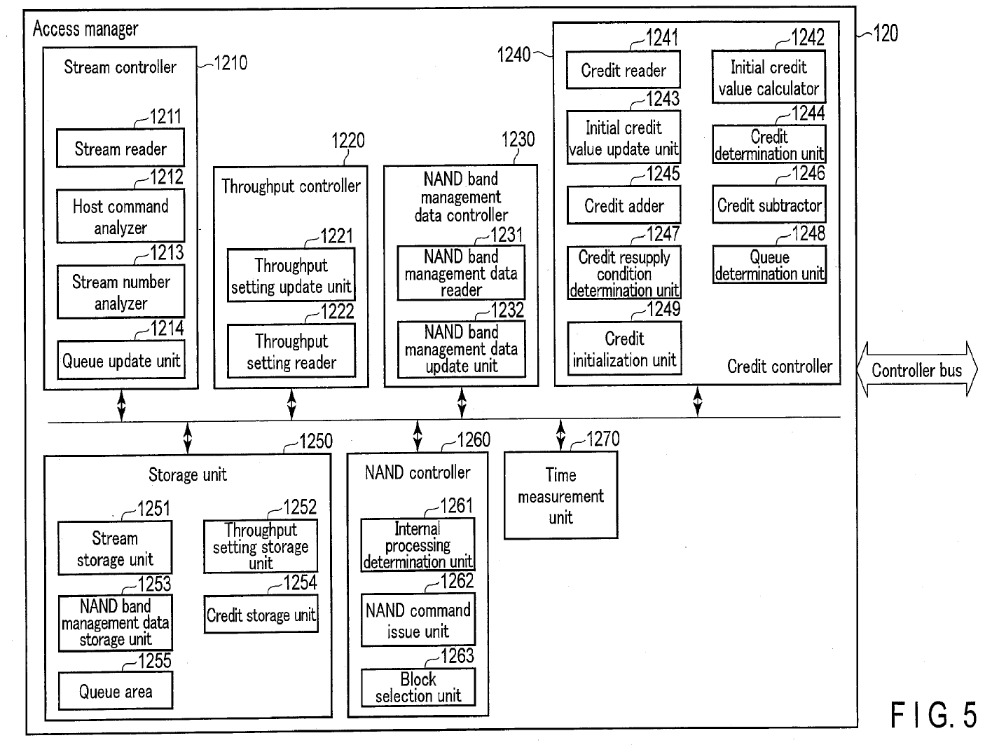

Namely, as shown in FIG. 5, for lower page reading, voltage VB, which distinguishes between the “A” state and the “B” state, is used as a read voltage. The read operation using voltage VB will be referred to as read operation BR. The read operation BR is an operation to determine whether or not the threshold voltage of a memory cell transistor MT is lower than voltage VB.

For upper page reading, voltage VA, which distinguishes between the “Er” state and the “A” state, and voltage VC, which distinguishes between the “B” state and the “C” state, are used as read voltages. The read operations using voltages VA and VC will be referred to as read operations AR and CR, respectively. Read operation AR specifies which memory cell transistor MT is in the erase state.

The memory cell array 11 may have other configurations. The memory cell array 11 may have the configuration described in, for example, U.S. patent application Ser. No. 12/407,403, entitled “THREE DIMENSIONAL STACKED NONVOLATILE SEMICONDUCTOR MEMORY”, filed on Mar. 19, 2009. It is also described in U.S. patent application Ser. No. 12/406,524 filed on Mar. 18, 2009, entitled “THREE DIMENSIONAL STACKED NONVOLATILE SEMICONDUCTOR MEMORY”; U.S. patent application Ser. No. 12/679,991 filed on Mar. 25, 2010, entitled “NON-VOLATILE SEMICONDUCTOR STORAGE DEVICE AND METHOD OF MANUFACTURING THE SAME”; and U.S. patent application Ser. No. 12/532,030 filed on Mar. 23, 2009, entitled “SEMICONDUCTOR MEMORY AND METHOD FOR MANUFACTURING SAME”. The entire contents of these patent applications are incorporated herein by reference.

<1-1-4> Configuration of Access Manager

Next, a configuration of the access manager will be described with reference to FIG. 5. FIG. 5 is a block diagram showing a configuration of the access manager 120.

As shown in FIG. 5, the access manager 120 includes a stream controller 1210, a throughput controller 1220, a NAND band management data controller 1230, a credit controller 1240, a storage unit 1250, a NAND controller 1260, and a time measurement unit 1270.

The stream controller 1210 includes a stream reader 1211, a host command analyzer 1212, a stream number analyzer 1213, and a queue update unit 1214.

The stream reader 1211 is, for example, a circuit, and reads a stream stored in a stream storage unit 1251. The host command analyzer 1212 is, for example, a circuit, and analyzes the content of a host command included in the stream read by the stream reader 1211. The stream number analyzer 1213 is, for example, a circuit, and analyzes the number of the read stream. This enables determination of which user the read stream relates to. The queue update unit 1214 is, for example, a circuit, and updates a queue area 1255. For example, the queue update unit 1214 inputs a command to the queue area 1255.

The throughput controller 1220 includes a throughput setting update unit 1221 and a throughput setting reader 1222.

The throughput setting update unit 1221 is, for example, a circuit, and updates a throughput setting stored in a throughput setting storage unit 1252. The throughput setting is data for determining the processing rate per unit time of the memory system 1. The throughput setting is updated by, for example, the host device 2. The throughput setting reader 1222 is, for example, a circuit, and reads the throughput setting stored in the throughput setting storage unit 1252.

The NAND band management data controller 1230 includes a NAND band management data reader 1231 and a NAND band management data update unit 1232.

The NAND band management data reader 1231 is, for example, a circuit, and reads NAND band management data from a NAND band management data storage unit 1253. The NAND band management data will be described later. The NAND band management data update unit 1232 is, for example, a circuit, and updates the NAND band management data stored in the NAND band management data storage unit 1253.

The credit controller 1240 includes a credit reader 1241, an initial credit value calculator 1242, an initial credit value update unit 1243, a credit determination unit 1244, a credit adder 1245, a credit subtractor 1246, a credit resupply condition determination unit 1247, a queue determination unit 1248, and a credit initialization unit 1249.

The credit reader 1241 is, for example, a circuit, and reads a credit stored in a credit storage unit 1254. The credit is data used for managing the access performance of each user. Details will be described later. The initial credit value calculator 1242 is, for example, a circuit, and calculates an initial credit value. The initial credit value is data included in the credit. Details will be described later. The initial credit value update unit 1243 is, for example, a circuit, and updates the initial credit value in the credit stored in the credit storage unit 1254. The credit determination unit 1244 is, for example, a circuit, and determines the credit read by the credit reader 1241. The credit adder 1245 is, for example, a circuit, and adds the initial credit value to the credit value included in the credit read by the credit reader 1241. The credit subtractor 1246 is, for example, a circuit, and subtracts a credit value corresponding to external access processing or internal access processing from the credit value in the credit read by the credit reader 1241. The credit resupply condition determination unit 1247 is, for example, a circuit, and determines whether or not the condition for adding the initial credit value to the credit value in the credit (such as a credit resupply condition) is satisfied. The queue determination unit 1248 is, for example, a circuit, and determines the content of a queue stored in the queue area 1255. The credit initialization unit 1249 is, for example, a circuit, and initializes the credit. The initialization means, for example, turning the valid flag included in the credit off.

The storage unit 1250 includes the stream storage unit 1251, the throughput setting storage unit 1252, the NAND band management data storage unit 1253, the credit storage unit 1254, and the queue area 1255.

The stream storage unit 1251 is, for example, a circuit, and stores a stream that the host interface circuit 110 receives from the host device 2. The stream storage unit 1251 stores, for example, a stream from the head to the end in the receiving order from the host device 2. The throughput setting storage unit 1252 is, for example, a circuit, and stores a throughput setting input by the throughput setting update unit 1221. The throughput setting storage unit 1252 stores a throughput setting for each stream number. The NAND band management data storage unit 1253 is, for example, a circuit, and stores NAND band management data for each stream number. The data structure of the NAND band management data will be described later. The credit storage unit 1254 is, for example, a circuit, and stores a credit for each stream number. The data structure of the credit will be described later. The queue area 1255 is, for example, a circuit, and includes a plurality of queues (such as a first queue, a second queue, and a third queue) for each stream number. The data structures of the queues will be described later.

Next, the data structure of the NAND band management data will be described. The NAND band management data includes an effective data size, a user read data size, a user write data size, an internal read data size, an internal write data size, a total read data size, a total write data size, a total access time, and an access time per unit time.

The effective data size is a size of the storage area assigned to a user (occupied by a user).

The user read data size is a size of data read by external access processing based on a user's read request.

The user write data size is a size of data written by external access processing based on a user's write request.

The internal read data size is a size of data read by internal access processing on the storage area assigned to a user.

The internal write data size is a size of data written by internal access processing on the storage area assigned to a user.

The total read data size is a total (sum) of the user read data size and the internal read data size.

The total write data size is a total (sum) of the user write data size and the internal write data size.

The total access time is an operating time of the NAND interface circuit 170 based on the internal access processing and external access processing on the storage area assigned to a user.

The access time per unit time is a time obtained by dividing the total access time by a unit time. This will also be referred to as a NAND band utilization amount.

Next, the data structure of the credit will be described. The credit includes a valid flag, an initial credit value, and a credit value.

The valid flag is on when the credit is valid. For example, storing data “1” means that the flag is on, whereas storing data “0” means the flag is off. The valid flag being on indicates that the credit is in a valid state, whereas the valid flag being off indicates that the credit is in an invalid state.

The initial credit value is calculated by the initial credit value calculator 1242 based on the NAND band management data and the throughput setting. The initial credit value is a value used when the credit adder 1245 adds a credit value. The initial credit value is a value that can be changed based on the throughput setting supplied from the host device 2.

The credit value is a value required for external access processing or internal access processing. Specifically, whenever external access processing or internal access processing is performed by the memory system 1, a credit value assigned to the external access processing or internal access processing is subtracted from the credit value. The credit value to be subtracted varies depending on, for example, the executed command. Since the processing time of the read operation is shorter than that of the write operation, the credit value for the read operation is smaller than that for the write operation. The credit value for each command is determined in accordance with the system.

The detailed uses of the valid flag, the initial credit value, and the credit value will be described later.

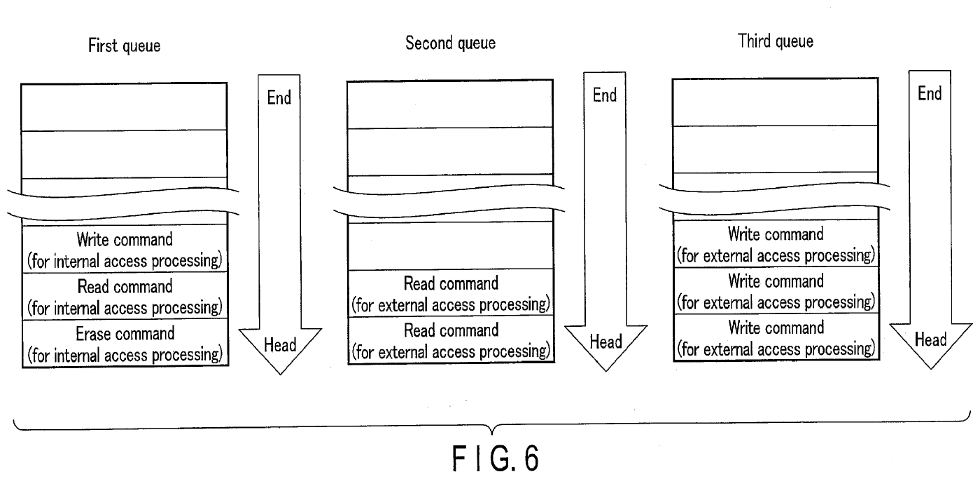

Next, the data structures of the queues will be described with reference to FIG. 6. As shown in FIG. 6, the queue area 1255 includes, for example, a first queue, a second queue, and a third queue. The queue has a data structure which allows the data input first to be output first. Such a data input/output system is called “First in First out (FIFO)”. Inputting data to the end of the queue is called “enqueueing”, and outputting data from the head of queue is called “dequeueing”. In a queue, data (a command) is enqueued from the end, and data is dequeued from the head in the enqueued order.

In the first queue, for example, a command for internal access processing (internal processing) is enqueued. The internal access processing includes, for example, compaction, defragmentation, and garbage collection. A need for this internal processing arises based on a request from a user (external access processing).

In the second queue, for example, a command relating to a read command of the host commands for external access processing (external processing) is enqueued.

In the third queue, for example, a command relating to a write command of the host commands for external access processing (external processing) is enqueued.

Referring back to FIG. 5, the remaining part of the configuration of the access manager 120 will be described. The NAND controller 1260 includes an internal access processing determination unit 1261, a NAND command issue unit 1262, and a block selection unit 1263.

The internal access processing determination unit 1261 is, for example, a circuit, and determines whether or not to perform internal access processing on a storage area (e.g., a block of a chip CP) for a stream. The NAND command issue unit 1262 is, for example, a circuit, and issues a NAND command to a chip CP. The block selection unit 1263 is, for example, a circuit, and selects a block on which internal access processing is performed.

The time measurement unit 1270 is, for example, a circuit, and measures a time required by the access manager 120 as appropriate.

The stream controller 1210, throughput controller 1220, NAND band management data controller 1230, credit controller 1240, and NAND controller 1260 in the access manager 120 may be firmware that operates on the CPU 130. The storage unit 1250 may be implemented in the DRAM 300. The time measurement unit 1270 may be implemented in the timer 150.

### <1-2> Operation

Next, an operation of the memory system 1 according to the present embodiment will be described. Hereinafter, an operation including external access processing and internal access processing will be described. For simplification, the description will be provided while focusing on a user, i.e., a stream number.

<1-2-1> Operation Including External Access Processing and Internal Access Processing

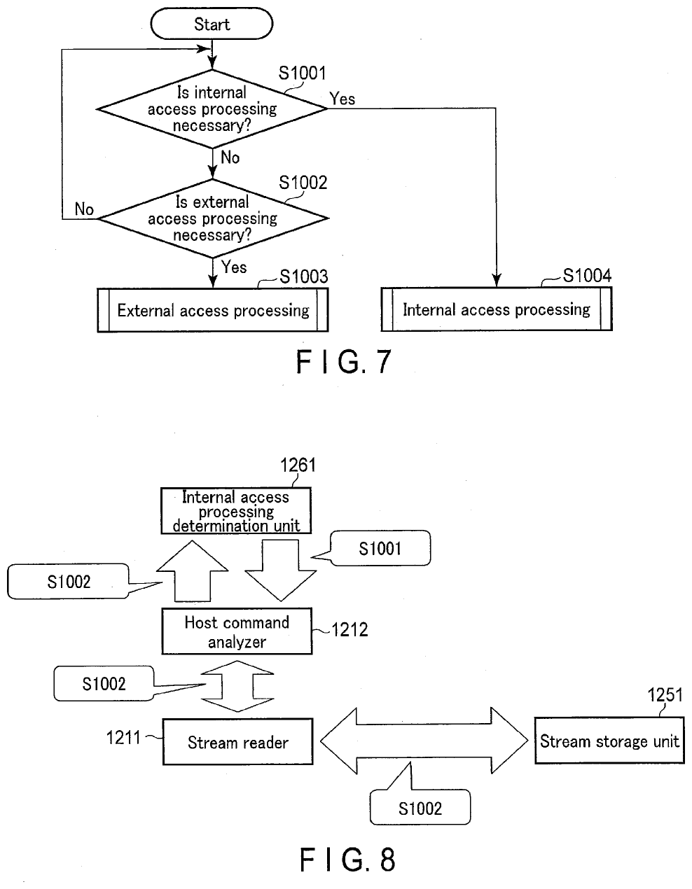

With reference to FIGS. 7 and 8, determination as to internal access processing and determination as to receipt of a host command in the memory system 1 will be described as a first operation of the memory system 1. FIG. 7 is a flowchart relating to determination as to internal access processing and determination as to receipt of a host command in the memory system 1. FIG. 8 is a block diagram showing determination as to internal access processing and determination as to receipt of a host command in the memory system 1. Hereinafter, descriptions will be provided with reference to both FIG. 7 and FIG. 8.

[S1001]

The memory system 1 according to the present embodiment may give a higher priority to internal access processing than to an order from the host device 2 (which is an order from a user, and will also be referred to as external access processing). In that case, the internal access processing determination unit 1261 first determines whether or not internal access processing is necessary for a stream number. Timing of executing S1001 may be provided by the time measurement unit 1270.

[S1002]

When the internal access processing determination unit 1261 determines that internal access processing is not necessary (NO in S1001), the host command analyzer 1212 determines whether or not the host command analyzer 1212 is in receipt of a host command. Specifically, the host command analyzer 1212 reads a stream stored in the stream storage unit 1251 via the stream reader 1211. The host command analyzer 1212 then determines whether or not a host command has been received based on whether or not there is a read stream. In other words, the host command analyzer 1212 determines whether or not external access processing is necessary. When the host command analyzer 1212 determines that external access processing is not necessary (NO in S1002), the memory system 1 repeats S1001.

When the host command analyzer 1212 determines that external access processing is necessary (YES in S1002), the memory system 1 performs processing based on the host command.

[S1004]

When the internal access processing determination unit 1261 determines that internal access processing is necessary for a stream (YES in S1001), the memory system 1 executes internal access processing.

<1-2-2> S1003

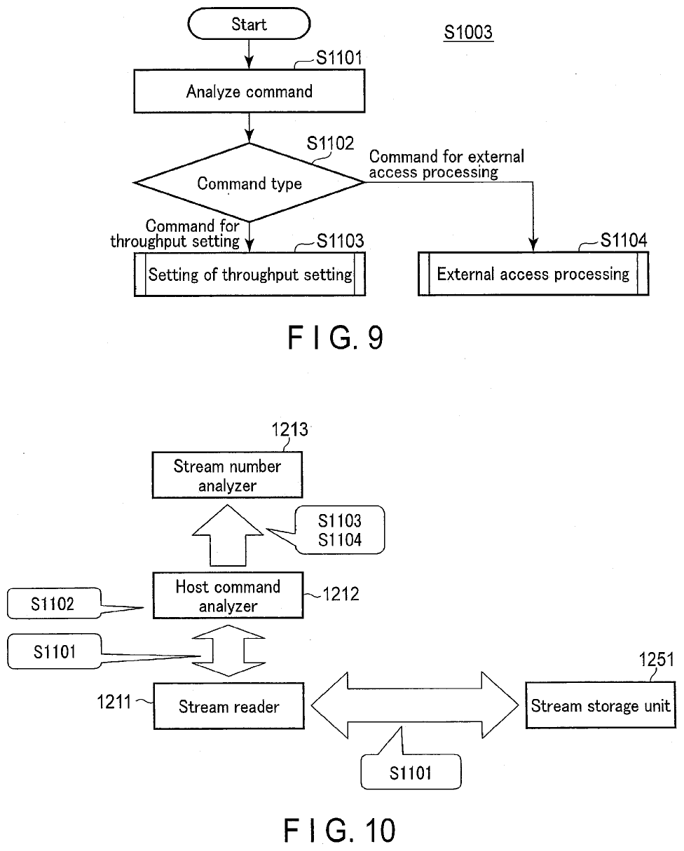

The operation of S1003 (a second operation of the memory system 1) will be described with reference to FIGS. 9 and 10. FIG. 9 is a flowchart of the operation of S1003. FIG. 10 is a block diagram showing the operation of S1003. Hereinafter, descriptions will be provided with reference to both FIGS. 9 and 10.

[S1101]

When processing based on a host command is performed, the host command analyzer 1212 receives a stream from the stream storage unit 1251 via the stream reader 1211, and analyzes a host command included in the stream.

[S1102]

The host command analyzer 1212 can determine the command type by analyzing the host command.

[S1103]

The host command analyzer 1212 sets a throughput setting when determining that the host command is a command for setting of a throughput setting in S1102. Therefore, the host command analyzer 1212 notifies the stream number analyzer 1213 that setting of a throughput setting will be performed.

[S1104]

The host command analyzer 1212 performs external access processing when determining that the host command is a command for external access processing in S1102. Therefore, the host command analyzer 1212 notifies the stream number analyzer 1213 that external access processing will be performed.

<1-2-3> S1103

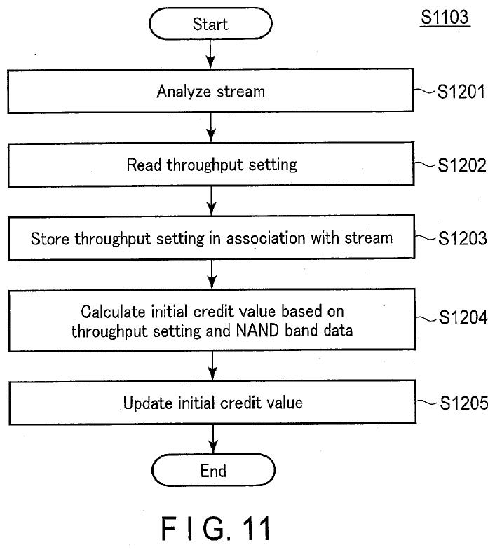

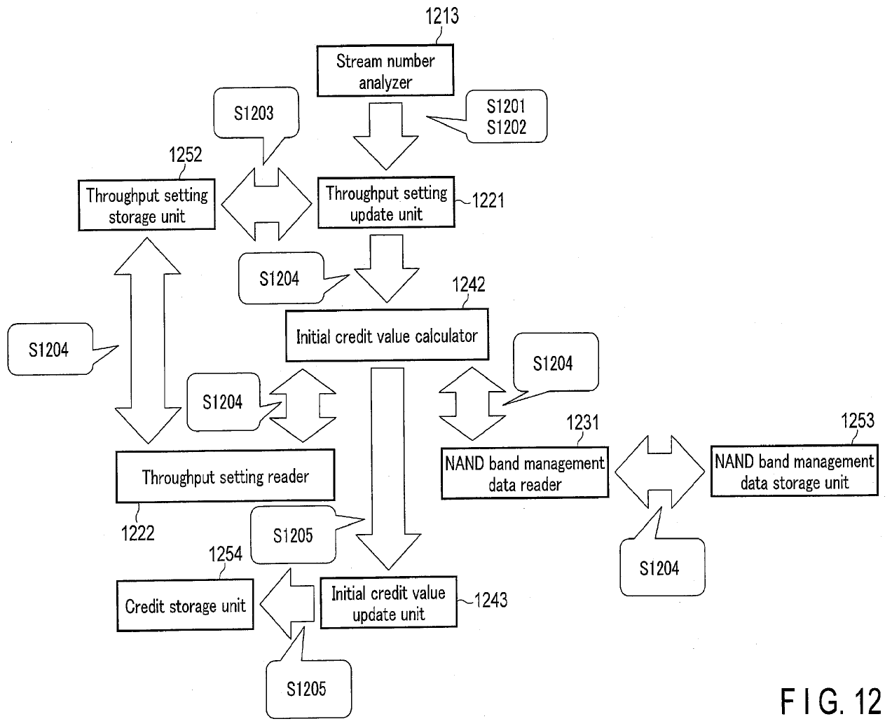

The operation of S1103 (a third operation of the memory system 1) will be described with reference to FIGS. 11 and 12. FIG. 11 is a flowchart of the operation of S1103. FIG. 12 is a block diagram showing the operation of S1103. Hereinafter, descriptions will be provided with reference to both FIGS. 11 and 12.

[S1201]

The stream number analyzer 1213 analyzes the number of a stream. Specifically, the stream number analyzer 1213 analyzes which of streams 0 to N the stream to be processed has.

[S1202]

The stream number analyzer 1213 reads a throughput setting included in the analyzed stream.

[S1203]

The throughput setting update unit 1221 stores the read throughput setting in the throughput setting storage unit 1252 in association with the number of the received stream.

[S1204]

The NAND band management data reader 1231 reads NAND band management data for the received stream from the NAND band management data storage unit 1253.

The throughput setting reader 1222 reads a throughput setting for the received stream from the throughput setting storage unit 1252.

The initial credit value calculator 1242 calculates an initial credit value based on the NAND band management data read by the NAND band management data reader 1231 from the NAND band management data storage unit 1253 and the throughput setting read by the throughput setting reader 1222 from the throughput setting storage unit 1252.

[S1205]

The initial credit value update unit 1243 updates an initial credit value for a stream which is stored in the credit storage unit 1254 with the initial credit value calculated by the initial credit value calculator 1242.

<1-2-4> S1104

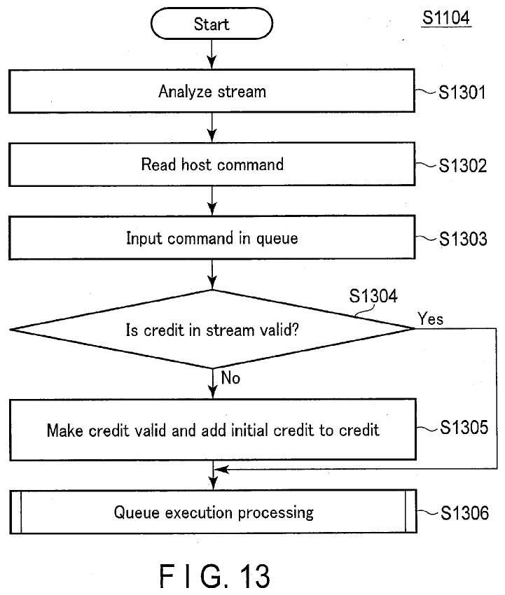

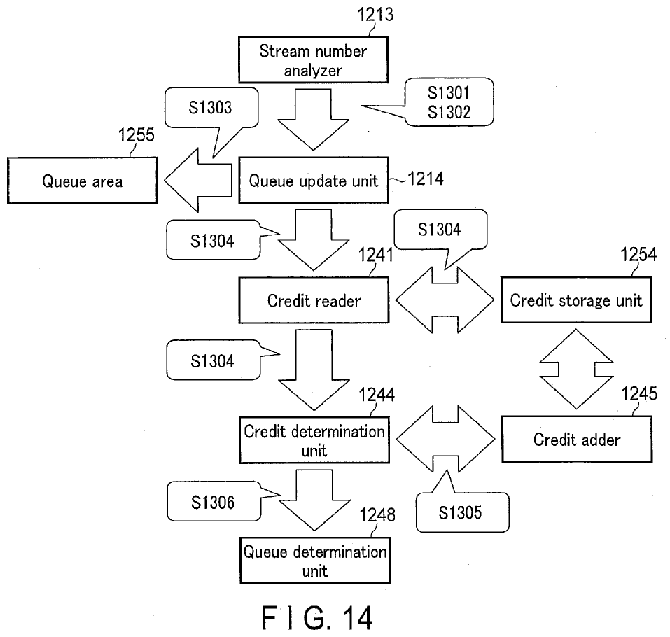

The operation of S1104 (a fourth operation of the memory system 1) will be described with reference to FIGS. 13 and 14. FIG. 13 is a flowchart of the operation of S1104. FIG. 14 is a block diagram showing the operation of S1104. Hereinafter, descriptions will be provided with reference to both FIGS. 13 and 14.

[S1301]

The stream number analyzer 1213 analyzes the number of a stream. Specifically, the stream number analyzer 1213 analyzes which of streams 0 to N the stream to be processed has.

[S1302]

The stream number analyzer 1213 reads a host command included in the analyzed stream.

[S1303]

The queue update unit 1214 stores the read host command in the queue area 1255. At this time, the queue update unit 1214 inputs the host command to an appropriate queue in accordance with the type of the host command.

[S1304]

The credit reader 1241 reads a credit relating to the stream from the credit storage unit 1254.

The credit determination unit 1244 determines whether or not the valid flag included in the read credit is on.

When the credit determination unit 1244 determines that the valid flag is not on (NO in S1304), the credit adder 1245 updates the valid flag to be on, and adds the initial credit value included in the read credit to the credit value.

[S1306]

When the credit determination unit 1244 determines that the valid flag is on (YES in S1304), or after S1301, the queue determination unit 1248 performs queue execution processing.

<1-2-5> S1306

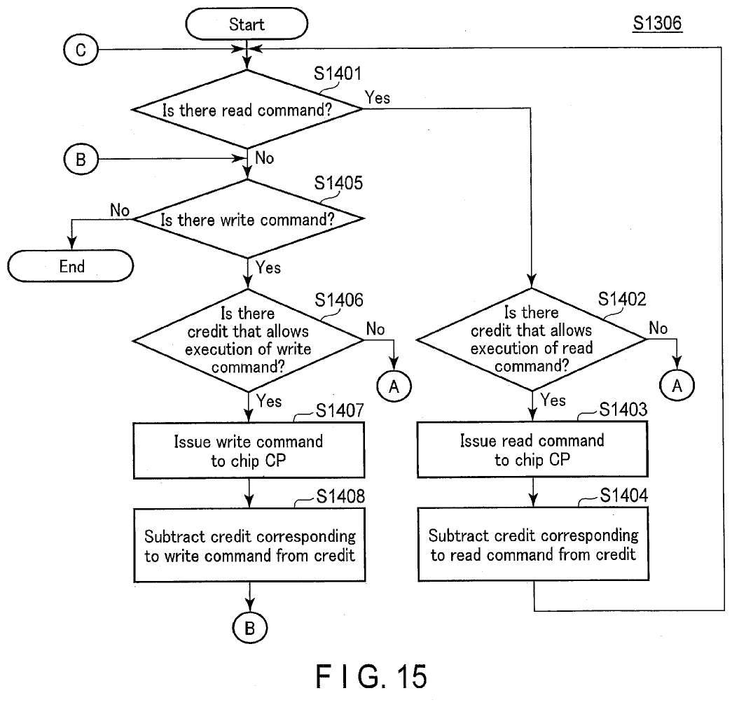

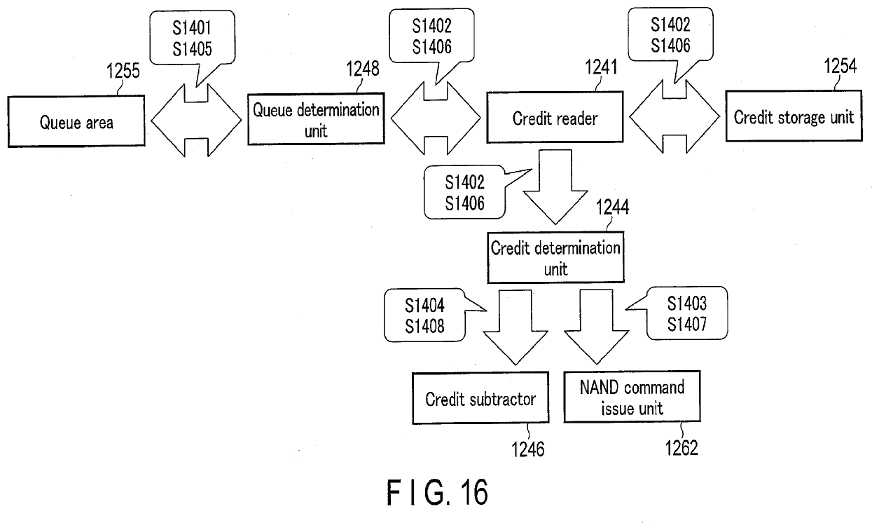

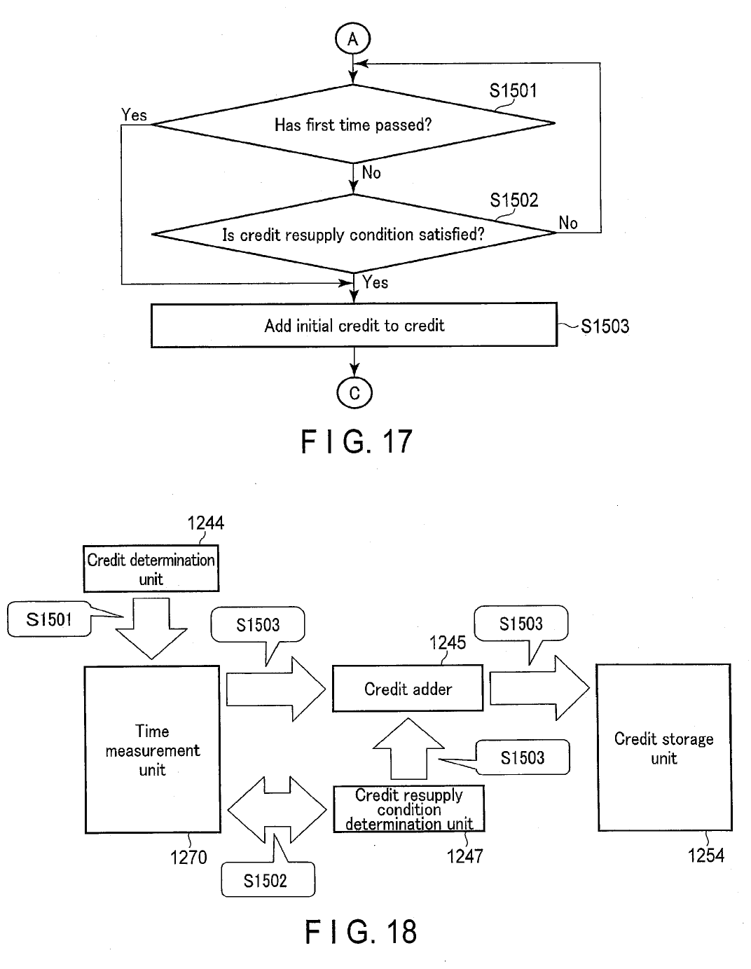

The operation of S1306 (a fifth operation of the memory system 1) will be described with reference to FIGS. 15 to 18. FIGS. 15 and 17 are a flowchart of the operation of S1306. FIGS. 16 and 18 are a block diagram showing the operation of S1306. Hereinafter, descriptions will be provided with reference to FIGS. 15 to 18.

[S1401]

The queue determination unit 1248 determines whether or not a read command is enqueued in the second queue of the queue area 1255.

[S1402]

When the queue determination unit 1248 determines that a read command is enqueued in the second queue (YES in S1401), the credit reader 1241 reads a credit from the credit storage unit 1254. The credit determination unit 1244 then determines whether or not the credit value included in the credit satisfies a condition required to execute the read command. For example, a first credit value is required to execute the read command. The credit determination unit 1244 then determines whether or not the credit value included in the credit exceeds the credit value required to execute the read command. When the credit determination unit 1244 determines that the credit value included in the credit does not exceed the credit value required to execute the read command (NO in S1402), an operation relating to addition of a credit value is performed. Details will be described later.

[S1403]

When the credit determination unit 1244 determines that the credit value included in the credit exceeds the credit value required to execute the read command (YES in S1402), the NAND command issue unit 1262 issues a read command to the chip CP and block designated by the stream.

[S1404]

The credit subtractor 1246 subtracts a credit value corresponding to the read command from the credit value.

[S1405]

When the queue determination unit 1248 determines that no read command is enqueued in the second queue (NO in S1401), the queue determination unit 1248 determines whether or not a write command is enqueued in the third queue. When the queue determination unit 1248 determines that no write command is enqueued in the third queue (NO in S1405), the operation ends.

When the queue determination unit 1248 determines that a write command is enqueued in the third queue (YES in S1405), the credit reader 1241 reads a credit from the credit storage unit 1254. The credit determination unit 1244 then determines whether or not the credit value included in the credit satisfies the condition required to execute the write command. For example, a second credit value (which is, for example, different from the first credit value) is required to execute the write command. The credit determination unit 1244 then determines whether or not the credit value included in the credit exceeds the credit value required to execute the write command. When the credit determination unit 1244 determines that the credit value included in the credit does not exceed the credit value required to execute the write command (NO in S1406), an operation relating to addition of a credit value is performed. Details will be described later.

[S1407]

When the credit determination unit 1244 determines that the credit value included in the credit exceeds the credit value required to execute the write command (YES in S1406), the NAND command issue unit 1262 issues a write command to the chip CP and block designated by the stream.

[S1408]

The credit subtractor 1246 subtracts a credit value corresponding to the write command from the credit value. After that, step S1405 is repeated.

Regarding write operations, it is possible to ascertain the credit value after a certain number of commands for write operations are accumulated, and collectively transmit a certain number of write commands to the chip CP.

Regarding read operations, when there is a credit value, a read command may be immediately transmitted to the chip CP.

[S1501]

Next, the operation relating to addition of a credit will be described with reference to FIGS. 17 and 18.

When the credit determination unit 1244 determines that the credit value included in the credit does not exceed the credit value required to execute the read command (NO in S1402), or determines that the credit value included in the credit does not exceed the credit value required to execute the write command (NO in S1406), the time measurement unit 1270 determines, for the credit, whether or not a first time has passed from addition of a credit.

[S1502]

When the time measurement unit 1270 determines, for the credit, that the first time has not passed from addition of a credit (NO in S1501), the credit resupply condition determination unit 1247 determines, for the credit, whether or not a credit resupply condition is satisfied. When the credit resupply condition determination unit 1247 determines, for the credit, that the credit resupply condition is not satisfied (NO in S1502), S1501 is repeated.

[S1503]

When the time measurement unit 1270 determines, for the credit, that the first time has passed from addition of a credit (YES in S1501), or the credit resupply condition determination unit 1247 determines, for the credit, that the credit resupply condition is satisfied (YES in S1502), the credit adder 1245 adds the initial credit value to the credit value stored in the credit storage unit 1254. Subsequently, the processing proceeds to S1401.

<1-2-6> Addition of Credit

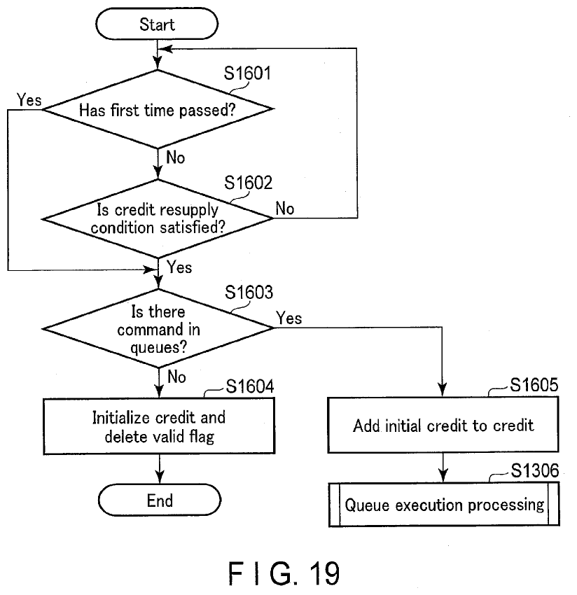

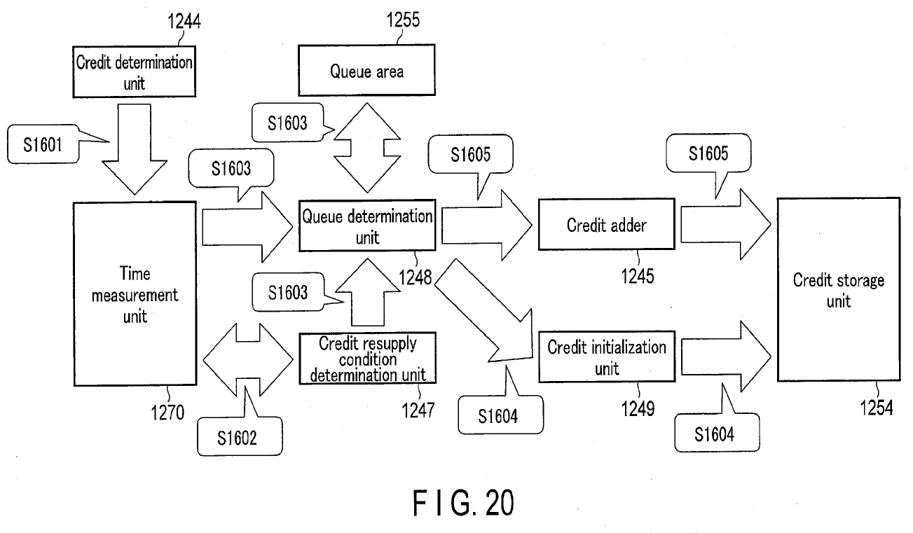

The operation relating to addition of a credit (a sixth operation of the memory system 1) will be described with reference to FIGS. 19 and 20. FIG. 19 is a flowchart of the operation relating to addition of a credit. FIG. 20 is a block diagram showing the operation relating to addition of a credit. Hereinafter, descriptions will be provided with reference to both FIGS. 19 and 20.

This operation relating to addition of a credit is performed as background processing for a valid credit. “An operation being performed as background processing” means that the operation is performed in parallel with the aforementioned operation.

[S1601]

The time measurement unit 1270 determines, for the credit, whether or not the first time has passed from addition of a credit.

[S1602]

When the time measurement unit 1270 determines, for the credit, that the first time has not passed from addition of a credit (NO in S1601), the credit resupply condition determination unit 1247 determines, for the credit, whether or not a credit resupply condition is satisfied. When the credit resupply condition determination unit 1247 determines, for the credit, that the credit resupply condition is not satisfied (NO in S1602), S1601 is repeated. As the credit resupply condition, “all users await addition (supply) of a credit value, and the NAND utilization rate (band) in the memory system 1 is 50% or less”, “all users await addition (supply) of a credit value, and the operation is in a command-awaiting state”, or the like is conceivable.

[S1603]

When the time measurement unit 1270 determines, for the credit, that the first time has passed from addition of a credit (YES in S1601), or the credit resupply condition determination unit 1247 determines, for the credit, that the credit resupply condition is satisfied (YES in S1602), the queue determination unit 1248 determines whether or not there is a command in the queues.

[S1604]

When the queue determination unit 1248 determines that there is no command in the queues (NO in S1603), the credit initialization unit 1249 initializes the credit.

Specifically, the valid flag is updated to be off.

[S1605]

When the queue determination unit 1248 determines that there is a command in the queues (YES in S1604), the queue adder 1245 adds the initial credit value to the credit value stored in the credit storage unit 1254. Subsequently, the processing proceeds to S1306.

<1-2-7> S1004

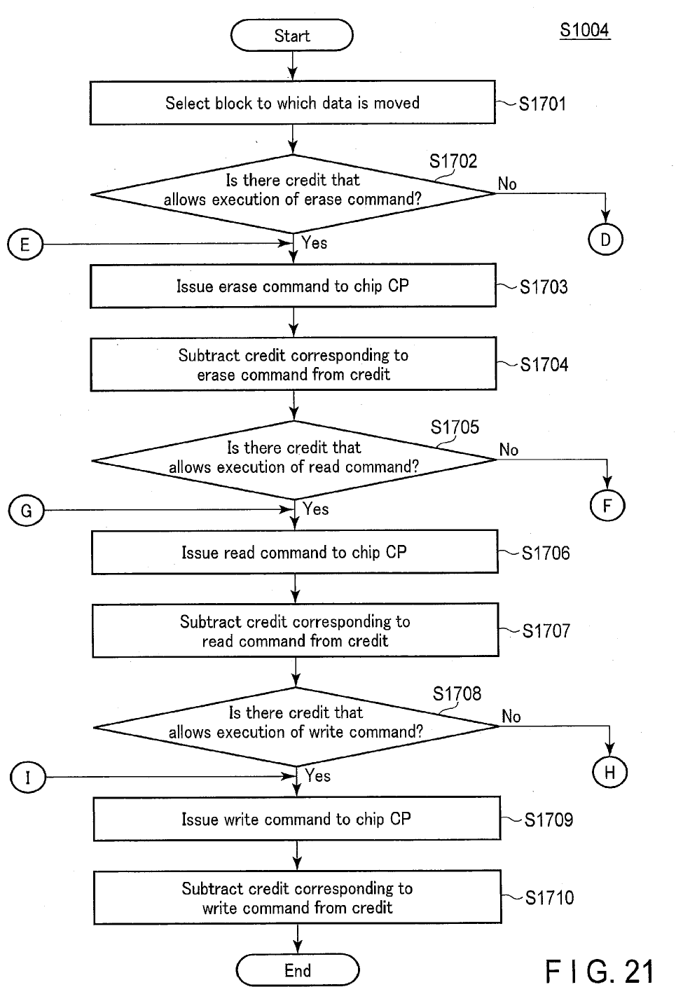

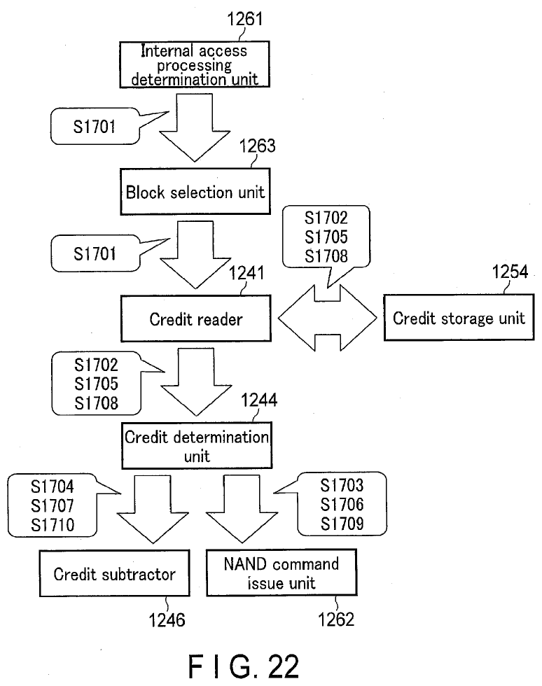

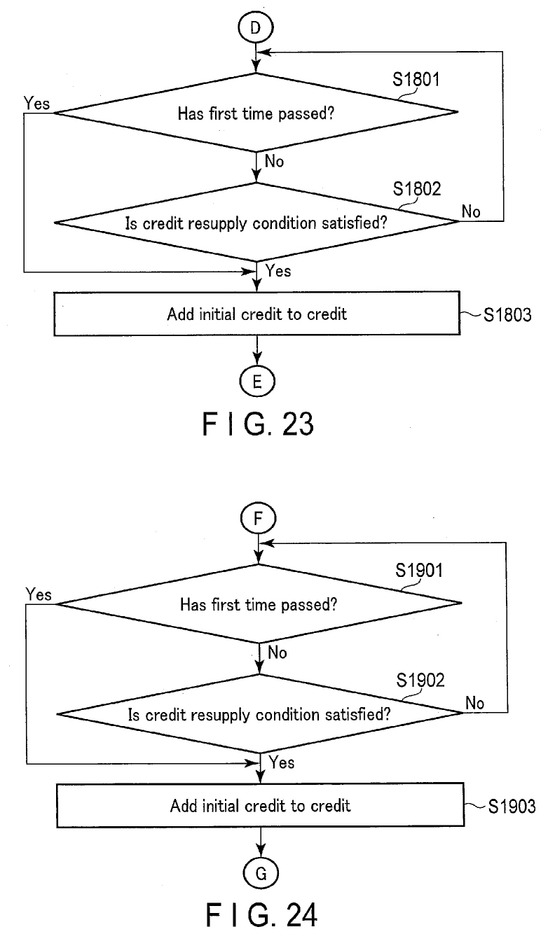

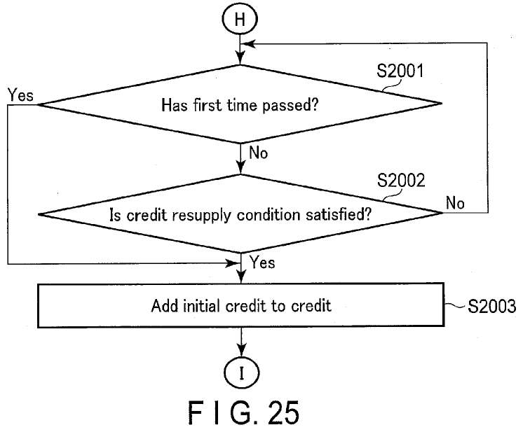

The operation of S1004 (a seventh operation of the memory system 1) will be described with reference to FIGS. 21 to 25. FIGS. 21 and 23 to 25 are a flowchart of the operation of S1004. FIG. 22 is a block diagram showing the operation of S1004. Hereinafter, descriptions will be provided with reference to FIGS. 21 to 25.

[S1701]

When the internal access processing determination unit 1261 determines that internal access processing is necessary for a stream (YES in S1001), the block selection unit 1263 selects a block of a chip CP on which internal access processing is performed. As an example of internal access processing, an operation relating to compaction will be described. In the compaction operation, first, data in the block to which data is moved (the block selected by the block selection unit 1263) is erased; secondly, data to be moved is read; and then, the read data is written in the block from which data has been erased.

[S1702]

The credit reader 1241 reads a credit from the credit storage unit 1254. The credit determination unit 1244 then determines whether or not the credit value included in the credit satisfies the condition required to execute an erase command. For example, a third credit value (which is, for example, different from the first or second credit value) is required to execute the erase command. The credit determination unit 1244 then determines whether or not the credit value included in the credit exceeds the credit value required to execute the erase command. When the credit determination unit 1244 determines that the credit value included in the credit does not exceed the credit value required to execute the erase command (NO in S1702), an operation relating to addition of a credit value is performed.

[S1703]

When the credit determination unit 1244 determines that the credit value included in the credit exceeds the credit value required to execute the erase command (YES in S1702), the NAND command issue unit 1262 issues an erase command to the chip CP designated by the stream and the block designated by the block selection unit 1263 in S1701. Accordingly, data in the block to which data is moved can be erased.

[S1704]

The credit subtractor 1246 subtracts a credit value corresponding to the erase command from the credit value.

[S1705]

The credit reader 1241 reads a credit from the credit storage unit 1254. The credit determination unit 1244 then determines whether or not the credit value included in the credit satisfies a condition required to execute a read command. For example, the first credit value is necessary to execute the read command. The credit determination unit 1244 then determines whether or not the credit value included in the credit exceeds the credit value required to execute the read command. When the credit determination unit 1244 determines that the credit value included in the credit does not exceed the credit value required to execute the read command (NO in S1705), an operation relating to addition of a credit value is performed.

When the credit determination unit 1244 determines that the credit value included in the credit exceeds the credit value required to execute the read command (YES in S1705), the NAND command issue unit 1262 issues a read command to the chip CP and block designated by the stream. Data to be moved is thereby read.

The credit subtractor 1246 subtracts a credit value corresponding to the read command from the credit value.

The credit reader 1241 reads a credit from the credit storage unit 1254. The credit determination unit 1244 then determines whether or not the credit value included in the credit satisfies the condition required to execute a write command. For example, the second credit value is necessary to execute the write command. The credit determination unit 1244 then determines whether or not the credit value included in the credit exceeds the credit value required to execute the write command. When the credit determination unit 1244 determines that the credit value included in the credit does not exceed the credit value required to execute the write command (NO in S1708), an operation relating to addition of a credit value is performed.

[S1709]

When the credit determination unit 1244 determines that the credit value included in the credit exceeds the credit value required to execute the write command (YES in S1708), the NAND command issue unit 1262 issues a write command to the chip CP and block designated by the stream. Data can thereby be written in the block from which data has been erased.

[S1710]

The credit subtractor 1246 subtracts a credit value corresponding to the write command from the credit value.

[S1801]

When the credit determination unit 1244 determines that the credit value included in the credit does not exceed the credit value required to execute the erase command (NO in S1702), the time measurement unit 1270 determines, for the credit, whether or not the first time has passed from addition of a credit.

[S1802]

When the time measurement unit 1270 determines, for the credit, that the first time has not passed from addition of a credit (NO in S1801), the credit resupply condition determination unit 1247 determines, for the credit, whether or not the credit resupply condition is satisfied. When the credit resupply condition determination unit 1247 determines, for the credit, that the credit resupply condition is not satisfied (NO in S1802), S1801 is repeated.

[S1803]

When the time measurement unit 1270 determines, for the credit, that the first time has passed from addition of the credit (YES in S1801), or the credit resupply condition determination unit 1247 determines, for the credit, that the credit resupply condition is satisfied (YES in S1802), the credit adder 1245 adds the initial credit value to the credit value stored in the credit storage unit 1254. Subsequently, the processing proceeds to S1703.

[S1901]

When the credit determination unit 1244 determines that the credit value included in the credit does not exceed the credit value required to execute the read command (NO in S1705), the time measurement unit 1270 determines, for the credit, whether or not the first time has passed from addition of a credit.

[S1902]

When the time measurement unit 1270 determines, for the credit, that the first time has not passed from addition of a credit (NO in S1901), the credit resupply condition determination unit 1247 determines, for the credit, whether or not the credit resupply condition is satisfied. When the credit resupply condition determination unit 1247 determines, for the credit, that the credit resupply condition is not satisfied (NO in S1902), S1901 is repeated.

[S1903]

When the time measurement unit 1270 determines, for the credit, that the first time has passed from addition of a credit (YES in S1901), or the credit resupply condition determination unit 1247 determines, for the credit, that the credit resupply condition is satisfied (YES in S1902), the credit adder 1245 adds the initial credit value to the credit value stored in the credit storage unit 1254. Subsequently, the processing proceeds to S1706.

[S2001]

When the credit determination unit 1244 determines that the credit value included in the credit does not exceed the credit value required to execute the write command (NO in S1708), the time measurement unit 1270 determines, for the credit, whether or not the first time has passed from addition of a credit.

[S2002]

When the time measurement unit 1270 determines, for the credit, that the first time has not passed from addition of a credit (NO in S2001), the credit resupply condition determination unit 1247 determines, for the credit, whether or not the credit resupply condition is satisfied. When the credit resupply condition determination unit 1247 determines, for the credit, that the credit resupply condition is not satisfied (NO in S2002), S2001 is repeated.

[S2003]

When the time measurement unit 1270 determines, for the credit, that the first time has passed from addition of a credit (YES in S2001), or the credit resupply condition determination unit 1247 determines, for the credit, that the credit resupply condition is satisfied (YES in S2002), the credit adder 1245 adds the initial credit value to the credit value stored in the credit storage unit 1254. Subsequently, the processing proceeds to S1709.

### <1-3> Advantageous Effects

According to the above-described embodiment, the memory system 1 can assign data (credit) necessary for access processing to each user. When executing external access processing based on a user's request, the memory system 1 subtracts a value necessary for the external access processing from the credit value. Similarly, when executing internal access processing of the memory system 1 not based on a user's request, the memory system 1 subtracts a value necessary for the internal access processing from the credit value. Accordingly, not only when external access processing is performed, but also when internal access processing is performed, an access to a chip can be appropriately controlled.

In other words, the above-described memory system 1 can appropriately control the NAND band utilization amount for each user by adopting credits.

As described above, the memory system 1 may be installed in a data center, etc. and shared by a plurality of users. In this case, a need for internal access processing invisible from outside the memory system 1 may arise due to the method of using the memory system 1 by a user, and the internal access processing may exert a load on the memory system 1.

For example, changing the usable storage capacity in the memory system 1 in accordance with the billing amount for the service managing the memory system 1 is conceivable. However, as mentioned above, internal access processing of the memory system 1 may increase due to the method of using the memory system 1 by a user with a low billing amount, depending on the method. In that case, access performance is allocated to the user with a low billing amount, which may influence an access of another user with a high billing amount to the memory system 1.

The present embodiment enables allocation of performance (resources) to a user appropriate to the fee paid by the user (profit of the service). Accordingly, a user pays a fee corresponding to performance needed. Therefore, a user who performs an access using an access pattern favorable for the memory system 1 can use the memory system 1 for a small fee. A data center side which adopts the memory system 1 according to the present embodiment can collect an appropriate fee from users, and can avoid complaints relating to performance.

### <2> Others

An embodiment of the present invention has been described above; however, the present invention is not limited to the above-described embodiment, and can be variously modified in practice without departing from the spirit of the invention. Furthermore, the above-described embodiment includes inventions at various stages, and various inventions are extracted by appropriately combining the disclosed structural elements. For example, even if some structural elements are deleted from the disclosed structural elements, the resultant structure can be extracted as an invention as long as the advantageous effects can be obtained.

1. A memory system comprising:
a nonvolatile memory device to store data; and
a memory controller configured to:
manage first information allocated to each user and including first management data;
perform first processing for an access to the nonvolatile memory device when an access request to the nonvolatile memory device has been received from the user and the first management data is equal to or larger than a first value; and
perform second processing for an access to the nonvolatile memory device when the first management data is equal to or larger than a second value.

2. The memory system according to claim 1, wherein the first management data varies between users.

3. The memory system according to claim 1, wherein the memory controller refrains from performing the first processing until the first management data becomes equal to or larger than the first value when an access request to the nonvolatile memory device has been received from the user and the first management data is not equal to or larger than the first value.

4. The memory system according to claim 1, wherein the memory controller refrains from performing the second processing until the first management data becomes equal to or larger than a second value when the first management data is not equal to or larger than the second value.

5. The memory system according to claim 1, wherein the memory controller updates the first management data based on second management data when a first condition is satisfied.

6. The memory system according to claim 1, wherein the second management data is included in the first information.

7. The memory system according to claim 5, wherein the second management data is determined based on a user's billing amount.

8. The memory system according to claim 1, wherein
the memory controller
subtracts the first value from the first management data when performing the first processing, and
subtracts the second value from the first management data when performing the second processing.

9. The memory system according to claim 1, wherein the memory controller determines whether or not the second processing needs to be performed.

10. The memory system according to claim 1, wherein
the first processing is processing based on the access request, and
the second processing is processing not based on the access request.

11. A memory controller configured to:
manage first information allocated to each user and including first management data;
perform first processing for an access to the nonvolatile memory device when an access request to the nonvolatile memory device has been received from the user and the first management data is equal to or larger than a first value; and
perform second processing for an access to the nonvolatile memory device when the first management data is equal to or larger than a second value.

12. The memory controller according to claim 11, wherein the first management data varies between users.

13. The memory controller according to claim 11, further configured to refrain from performing the first processing until the first management data becomes equal to or larger than the first value when an access request to the nonvolatile memory device has been received from the user and the first management data is not equal to or larger than the first value.

14. The memory controller according to claim 11, further configured to refrain from performing the second processing until the first management data becomes equal to or larger than a second value when the first management data is not equal to or larger than the second value.

15. The memory controller according to claim 11, further configured to update the first management data based on second management data when a first condition is satisfied.

16. The memory controller according to claim 11, wherein the second management data is included in the first information.

17. The memory controller according to claim 15, wherein the second management data is determined based on a user's billing amount.

18. The memory controller according to claim 11, further configured to:
subtract the first value from the first management data when performing the first processing, and
subtract the second value from the first management data when performing the second processing.

19. The memory controller according to claim 11, further configured to determine whether or not the second processing needs to be performed.

20. The memory controller according to claim 11, wherein
the first processing is processing based on the access request, and
the second processing is processing not based on the access request.
